(19) United States
(12) Patent Application Publication
(10) Pub. No.: US 2005/0173882 A1
(43) Pub. Date: Aug. 11, 2005

(54) Torsion suspension

(75) Inventors: Rodscha Drabon, Paderborn (DE); Leonhard Rose, Borchen (DE); Robert Rissling, Paderborn (DE)

Correspondence Address: HENRY M FEIEREISEN, LLC, 350 FIFTH AVENUE, SUITE 4714, NEW YORK, NY, 10118, US

(73) Assignee: BENTELER AUTOMOBILTECHNIK GMBH, Paderborn (DE)

(21) Appl. No.: 11/009,413

(22) Filed: Dec. 10, 2004

(30) Foreign Application Priority Data
Dec. 11, 2003 (DE) 103 57 885.4

(51) Int. Cl. B60G 21/055

(52) U.S. Cl. 280/124.107; 280/124.116

(57) ABSTRACT

A torsion suspension includes two longitudinal control arms having front ends and rear ends in travel direction and a torsion axle extending transversely to and interconnecting the longitudinal control arms. A bearing assembly swingably supports the front ends of the longitudinal control arms in relation to a vehicle body. Coupled to each the rear ends of the longitudinal control arms are transverse control arms for absorbing lateral forces.

### CROSS-REFERENCES TO RELATED APPLICATIONS

This application claims the priority of German Patent Application, Serial No. 103 57 885.4, filed Dec. 11, 2003, pursuant to 35 U.S.C. 119(a)-(d).

### BACKGROUND OF THE INVENTION

The present invention relates, in general, to a torsion suspension.

Nothing in the following discussion of the state of the art is to be construed as an admission of prior art.

Torsion suspensions, including twist beam suspensions, are intended in combination with suitable damping means to attenuate bumps and vibrations, caused during travel of a vehicle and transmitted from the roadway via the wheel, and to direct the bumps and vibrations into the vehicle body. Twist beam suspensions generally have a simple structure so as to require only little space and exhibit good kinematic properties. Typically, a twist beam suspension includes longitudinal control arms which are connected by a torsion axle which effects during simultaneous compression a longitudinal control arm characteristic, and during alternating compression a semi-trailing arm characteristic. The torsion axle further provides stabilization to reduce body tilt in curves.

Mounted to each of the longitudinal control arms of the twist beam suspension is a primary bearing for attachment of the twist beam suspension to the vehicle body, a spindle support for securement of the wheel, a securement for support of a shock absorber between the twist beam suspension and the vehicle body, and a spring support for a respective helical compression spring. Prior art twist beam suspensions have typically a bending-resistant, torsionally yielding torsion axle as well as bending-resistant and torsion-resistant longitudinal control arms. The torsion axles as well as the longitudinal control arms may be made solid or hollow of sheet metal or by a casting process.

Depending on a distance of the wheel bearings from the primary bearings and depending on the transverse rigidity of the primary bearings, normally implemented as rubber-metal bearings, the steer angle of the twist beam suspension varies during cornering, possibly causing the motor vehicle to oversteer. To compensate for oversteer, particularly configured primary bearings have been proposed, as disclosed, for example, in U.S. Pat. No. 5,954,350.

FIG. 1 shows a plan view of a prior art twist beam suspension, generally designated by reference numeral 1 and including two longitudinal control arms 2, 3 having front ends 5, 6 and rear ends 9, 10. The longitudinal control arms 2, 3 are interconnected by a torsion axle 4 which extends transversely to the longitudinal control arms 2, 3. The front ends 5, 6 of the longitudinal control arms 2, 3 have primary bearings 7, 8 for swingably supporting the twist beam suspension to a limited degree upon a not shown vehicle body. The primary bearings 7, 8 are implemented as rubber-metal bearings. Projecting laterally from the rear ends 9, 10 of the longitudinal control arms 2, 3 are spindles 11, 12 for rotatably supporting not shown right and left wheels.

FIG. 2 shows a schematic illustration of the twist beam suspension 1 to depict its behavior when exposed to a lateral force F, as indicated by the arrow. Indicated to the left of FIG. 2 is a coordinate system depicting the longitudinal axis L in longitudinal direction, the transverse axis Q, and the vertical axis V of the longitudinal control arms 2, 3, with the transverse axis Q extending transversely to the travel direction, and the vertical axis V extending perpendicular to the longitudinal axis L and perpendicular to the transverse axis Q. The lateral force F is encountered, for example, during right turns predominantly on the curve-outer wheel. A lateral guide force is involved here which attacks the contact area of the wheels 13, 14. The lateral force F causes the entire twist beam suspension 1 to tilt about an angle α in relation to the central longitudinal axis MLA of the vehicle. As a result, a forward longitudinal force F_{R} acts on a right bearing bush of the primary bearing 8, and a backward longitudinal force F_{L} acts on a left bearing bush of the primary bearing 8. Accordingly, the twist beam suspension 1 rotates in counterclockwise direction, so that the steer angle varies in the direction of arrow P, causing oversteer of the vehicle. Depending of the configuration of the primary bearings 7, 8, a lateral slip of the twist beam suspension 1 may additionally take place.

It would therefore be desirable and advantageous to provide an improved torsion suspension for a motor vehicle to obviate prior art shortcomings and to exhibit better dynamics of vehicle movement while being lighter in construction.

### SUMMARY OF THE INVENTION

According to one aspect of the present invention, a torsion suspension includes two longitudinal control arms having front ends and rear ends in travel direction, a torsion axle extending transversely to and interconnecting the longitudinal control arms, a bearing assembly for swingably supporting the front ends of the longitudinal control arms in relation to a vehicle body, and transverse control arms coupled to the rear ends of the longitudinal control arms in one-to-one correspondence for absorbing lateral forces.

As used in the specification and claims, the term “transverse control arm” relates generally to a link that extends at an angle to the longitudinal control arm. The transverse control arm may also extend at a slant to the longitudinal control arm to assume the function of a semi-trailing arm.

Transverse control arms absorb a majority of introduced lateral forces during cornering to thereby provide a toe correcting function to adjust toe at least of the outer wheel in the curve so as to counteract oversteer of the motor vehicle. The additional transverse control arms transmit little lateral forces onto the primary bearings. As a consequence, the primary bearings can be constructed with little transversal rigidity, without adversely affecting the driving behavior. Little transversal rigidity may even be desired in accordance with the present invention in order to allow a shift of the front ends of the longitudinal control arms transversely to the travel direction so that this toe correcting function is able to realize an additional toe adjustment that acts against oversteer. It is hereby suitable to construct the transverse control arms relatively hard, i.e. transversely rigid, in order to realize the desired toe correction by transverse shift in the primary bearings, and to prevent the entire torsion suspension from shifting in parallel relationship to the initial disposition. Rather, a kinematic system is desired in which a parallelogram shiftable in the area of the primary bearing is displaced with a fix point in midsection between the transverse control arms.

According to another feature of the present invention, the longitudinal control arms may be constructed for attachment of wheels, with the transverse control arms coupled to the longitudinal control arms at a location behind a wheel axle of the wheels, as viewed in travel direction. Although it is in general conceivable to arrange the longitudinal control arms in the area of the center axis of the wheel bearings, this is, however, not desired because the lateral forces would be transmitted almost entirely onto the transverse control arms, thereby considerably limiting toe correction through displacement of the longitudinal control arms in the primary bearings. By coupling the transverse control arms to the longitudinal control arms at a location behind the center axis of the wheel bearings, as viewed in travel direction, the lateral force is distributed over the transverse control arms and the primary bearings. Reactive forces in the primary bearings and the transverse control arms are dependent on the distance of the wheel bearing from the transverse control arms or primary bearing. Depending on a dimensioning of these length ratios, different reactive force are realized on the primary bearing or transverse control arm, whereby the reactive force on the transverse control arm should be greater than the reactive force on the primary bearing, when a lateral force is applied transversely to the travel direction. In other words, the distance of the transverse control arm from the wheel bearing is smaller than the distance of the primary bearing from the wheel bearing.

According to another feature of the present invention, the longitudinal control arms are defined by a longitudinal axis extending in a longitudinal direction, a transverse axis extending transversely to the travel direction, and a vertical axis extending upwards in perpendicular relationship to the longitudinal axis and in perpendicular relationship to the transverse axis, wherein the longitudinal control arms may have at least one length section which extends between a connection area of the torsion axle and the transverse control arms and has a bending resistance which is smaller with respect to bending stress about the vertical axis than with respect to bending stress about the transverse axis. Compared to conventional twist beam suspensions without additional transverse control arm, a torsion suspension according to the invention encounters significantly smaller bending moments about the vertical axis of the longitudinal control arms when exposed to lateral forces. As a result, the longitudinal control arms can be constructed more flexible in relation to their vertical axis than in conventional twist beam suspensions. Of course, the longitudinal control arms should be constructed rigid enough in relation to flexure about the transverse axis in order to allow introduction of moments into the torsion suspension and via the torsion suspension into the second longitudinal control arm for realizing the desired compression characteristic. The longitudinal control arms can thus be configured to have a greater resistance to flexure about their transverse axis than to flexure about their vertical axis. As a consequence of the force conditions acting in the longitudinal control arms, it is possible to save significant material in the area of the longitudinal control arms.

In general, it is also possible to adjust the resistance against flexure in longitudinal control arms of metal through targeted local heat treatment, without requiring significant geometric modification of known constructions. For weight-saving reasons, it is, however, currently preferred to use longitudinal control arms which, when undergoing flexure, have a section modulus which is smaller in relation to the vertical axis than a section modulus of the transverse control arms undergoing flexure. The section modulus depends substantially on a cross sectional construction of the longitudinal control arms. As a result of the desired section moduli, a torsion suspension according to the present invention can be configured such as to extend in cross section spatially less in direction of its transverse axis than in direction of its vertical axis. The longitudinal control arm may, for example, be implemented by a relatively high rectangular profile with slight width, with the section moduli of the longitudinal control arm undergoing flexure being dimensioned in such a manner that the longitudinal control arm is targeted to undergo flexure about its vertical axis on turns. Thus, the toe of the rear wheel changes not only as a result of lateral shift of the primary bearings but also as a result of flexure of the longitudinal control arms about their respective vertical axis. Although any weight saving in the area of the longitudinal control arms is compensated in part by the provision of additional transverse control arms, a lower weight is overall realized while significantly improving toe guidance and spring characteristic of the torsion suspension.

The transverse control arms may extend at any angle deviating from 90° in relation to the longitudinal control arms. Currently preferred is however an arrangement of the transverse control arms transversely to the travel direction. In this way, the fraction of normal forces is the greatest in the bearing areas of the transverse control arms upon the vehicle body and the longitudinal control arms, and there is no need to absorb any additional shearing forces which can be absorbed, as usual, by the primary bearings.

According to another feature of the present invention, the transverse control arms may have each at least two struts, with each strut hinged to the vehicle body, on one hand, and hinged to a corresponding one of the longitudinal control arms, on the other hand. Suitably, the section modulus in relation to torsion may also be reduced, when the section modulus is reduced in relation to flexure so that the wheel camber changes as a result of torsion of the longitudinal control arms during compression. The two link struts may be articulated to the longitudinal control arms at different levels, thereby defining upper and lower struts, so as to compensate for undesired changes in camber. Suitably, the upper and lower struts may have different lengths in order to influence the compression behavior in a desired manner. In other words, the upper strut may be shorter than the lower strut, or vice versa. Depending on the encountered lateral force and depending on the degree of compression, the wheel may undergo a forced toe adjustment and change in camber. An essential advantage of this configuration of a torsion suspension according to the invention resides in the fact that toe adjustment or change in camber can be used as toe correcting function or camber correction function in a desired manner and independently from one another in a very cost-efficient manner.

According to another feature of the present invention, the upper strut may be implemented as a spring strut assembly having a shock absorber and a helical compression spring surrounding the shock absorber. This type of spring strut assembly in combination with a lower transverse control arm is oftentimes referred to as “McPherson strut” and realizes a change of camber width and toe width during compression and affords a torsion suspension according to the invention a particular compression behavior. In general, there is no need within the scope of the invention to arrange the link struts of a transverse control member necessarily in a common transverse plane of the motor vehicle. In particular, when the upper link strut is constructed in the form of a spring strut assembly, it may be suitable for force introduction into the spring strut assembly to dispose the spring strut assembly in the area of the wheel axis and to connect the spring strut assembly, at least indirectly, to the longitudinal control arm. The longitudinal center axis of the spring strut assembly may spatially intersect the wheel axis.

According to another feature of the present invention, the longitudinal control arms may be constructed in the form of upright metal bands. Metal bands may be made from punched bent parts of substantially constant thickness, with the ratio between height and thickness preferably greater than 5:1. The height of the metal band may vary over the longitudinal dimension of the longitudinal control arm to suit a need at hand. For example, the height may be sized greater in an area of attachment of the torsion suspension than in other areas by constructing wider zones on the upper edge and/or lower edge of the metal band.

According to another feature of the present invention, a wheel mounting may be constructed in one piece with the metal bands. The wheel mounting may be integrated directly in the metal band, when the metal band is high enough. For weight-saving reasons, it may be suitable to dimension the height of the metal band small enough whereby the wheel mounting need not necessarily coincide with the course of the longitudinal control arm or metal band.

According to another feature of the present invention, the wheel mounting, i.e. the wheel axis, may extend above the longitudinal control arms. In this case, the metal bands may be configured with an upwardly widening flanged expansion to thereby provide the upright metal band with a substantially T-shaped configuration. As a consequence of the single-piece configuration of the wheel mounting with the longitudinal control arms, a manufacturing step is saved because there is no need to connect a separate wheel mounting with the longitudinal control arms, e.g. by material union. Of course, the scope of the present invention covers also the provision of a separate wheel mounting which can be connected to the longitudinal control arms by adhesives, mechanical connectors, form-locking manner, or through material union, such as, e.g. welding.

A torsion suspension as a type of an expanded twist beam suspension combines advantageous driving dynamics of a multilink wheel suspension with the advantages in cost, packaging and weight of twist beam suspension.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a plan view of a prior art twist beam suspension;

FIG. 2 is a schematic illustration of the prior art twist beam suspension of FIG. 1;

FIG. 3 is a schematic illustration of a torsion suspension according to the present invention during straight travel;

FIG. 4 is a schematic illustration of the torsion suspension of FIG. 3 during turning and cornering;

FIG. 5 is a schematic illustration of another embodiment of a torsion suspension according to the present invention;

FIG. 6 is a plan view of a longitudinal control arm for a torsion suspension according to the present invention;

FIG. 6a is a sectional view of the longitudinal control arm, taken along the line A-A in FIG. 6;

FIG. 7 is a schematic rear view of yet another embodiment of a torsion suspension according to the present invention;

FIG. 8 is a schematic rear view of still another embodiment of a torsion suspension according to the present invention;

FIG. 9 is a plan view of a modification of the torsion suspension of FIG. 8;

FIG. 10 is a side view of the torsion suspension of FIG. 9; and

FIG. 11 is a top and side perspective view of the torsion suspension of FIG. 9.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

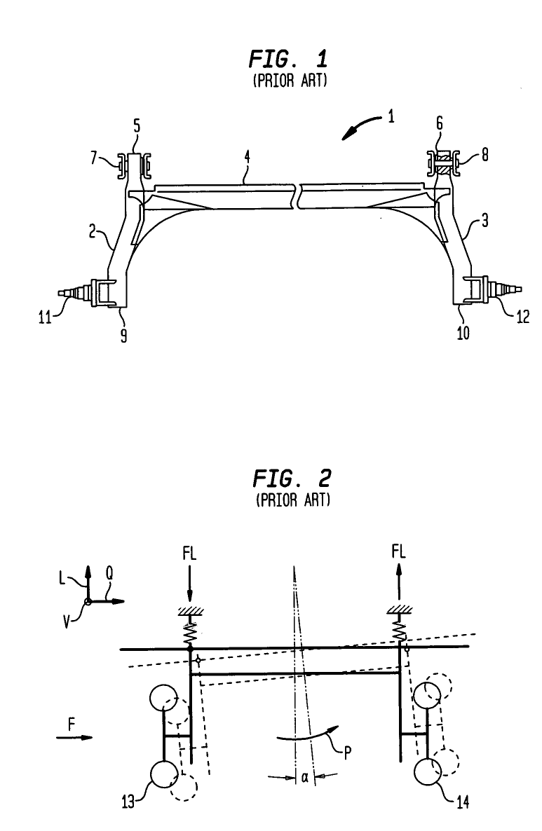

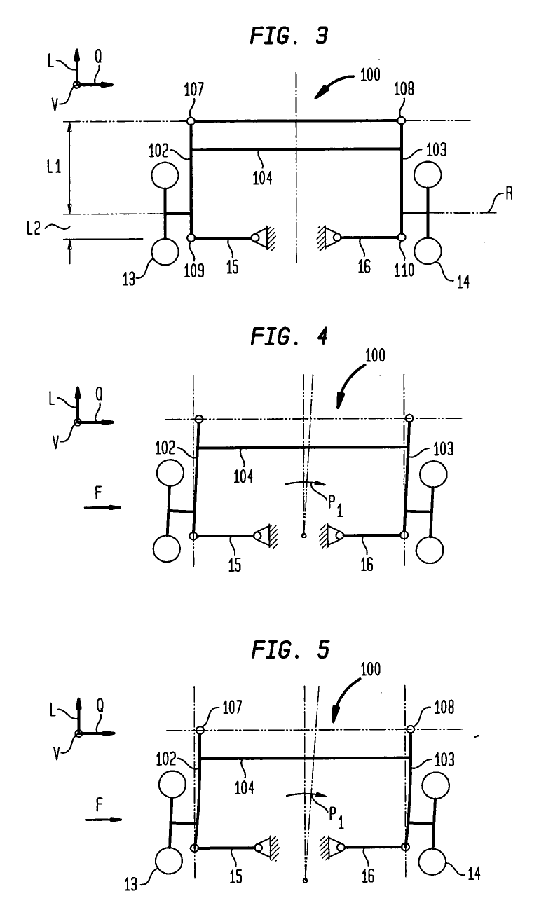

Turning now to the drawing, and in particular to FIG. 3, there is shown a schematic illustration of a torsion suspension according to the present invention, generally designated by reference numeral 100. In the following description, parts corresponding with those in FIGS. 1 and 2 will be identified by corresponding reference numerals, each increased by “100. As shown in FIG. 3, the torsion suspension 100 includes two longitudinal control arms 102, 103 and by a torsion axle 104 which extends transversely to and interconnects the longitudinal control arms 102, 103. The front ends of the longitudinal control arms 102, 103 have primary bearings 107, 108 for swingably supporting the torsion suspension 100 to a limited degree upon a not shown vehicle body. Projecting laterally from the longitudinal control arms 102, 103 are spindles for rotatably supporting right and left wheels 13, 14.

Disposed on the rear ends 109, 110 of the longitudinal control arms 102, 103 are additional transverse control arms 15, 16 which extend at a right angle to the longitudinal control arms 102, 103. Typically, the primary bearings 107, 108 are spaced from the wheel axis R at a distance L₁ which is greater than a distance L₂ of the transverse control arms 15, 16 from the wheel axis R. As a consequence, reactive forces acting transversely to the travel direction of the vehicle behave in the area of the primary bearings 107, 108 and the transverse control arms 15, 16 inversely proportional to a lever ratio L₁:L₂. As the longitudinal control arms 102, 103 are supported transversely rigid on the vehicle body and as the primary bearings 107, 108 yield, the torsion suspension 100 undergoes a parallel shift, as shown in FIG. 4. As a result, the steer angle varies in the direction of arrow P₁ clockwise, causing in theory understeer of the vehicle. Of course, the resiliency, i.e. transversal rigidity, in the primary bearings 107, 108 can be adjusted to realize a neutral toe attitude of 0°, i.e. the steer angle does not change.

The steer angle is not only dependent on the transversal rigidity of the primary bearings 107, 108 and the transverse control arms 15, 16 but also on the resistance against flexure of the longitudinal control arms 102, 103. Assuming that the rear ends 109, 110 of the longitudinal control arms 102, 103 are fixed bearings, the lateral force F introduces a bending moment into the longitudinal control arms 102, 103, causing flexure of the longitudinal control arms 102, 103 and a change of the steer angle in the direction of arrow P₁. In other words, oversteer is counteracted in dependence on the section modulus of the longitudinal control arms 102, 103. FIG. 5 shows the behavior of the torsion suspension 100, when exposed the lateral force F during cornering and having flexible longitudinal control arms 102, 103. As a consequence, the change of the steer angle is more pronounced compared to the embodiment of FIG. 4, causing greater tilt of the wheels 13, 14.

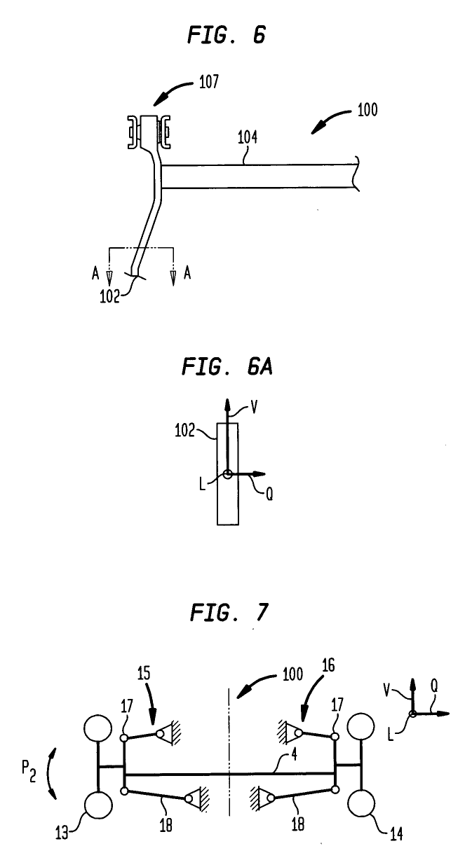

Referring now to FIG. 6, there is shown a plan view of the longitudinal control arm, for example longitudinal control arm 102, of the torsion suspension 100 according to the present invention. As shown in particular in FIG. 6a, which is sectional view of the longitudinal control arm 102, taken along the line A-A in FIG. 6, it can be seen that the longitudinal control arm 102 is of small width while still having sufficient bending resistance against flexure about its transverse axis as its height exceeds its width.

FIG. 7 shows a schematic rear view of a variation of the torsion suspension 100 according to the present invention. Parts corresponding with those in FIG. 3 are denoted by identical reference numerals and not explained again. The description below will center on the differences between the embodiments. In this embodiment, the transverse control arm 15 includes an upper link strut 17 and a lower link strut 18 in spaced-apart relationship. Although FIG. 7 shows, by way of example only, the provision of link struts 17, 18 of different lengths, it is certainly conceivable to configure the link struts 17, 18 of same length. The link struts 17, 18 assume the function to control camber of the wheels. The provision of two link struts 17, 18 enables absorption of torsional moments acting in the longitudinal control arms 102, 103 about their longitudinal direction so that the longitudinal control arms 102, 103 can be constructed even lighter in weight to improve the driving dynamics and the overall weight of the motor vehicle. Arrow P₂ indicates the movement direction of the left wheel 13 of the torsion suspension 100 from this perspective.

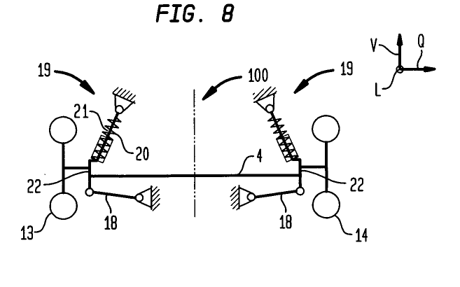

Referring now to FIG. 8, there is shown a modification of the torsion suspension 100 of FIG. 7. Parts corresponding with those in FIG. 7 are denoted by identical reference numerals and not explained again. The description below will center on the differences between the embodiments. In this embodiment, the upper link strut 17 is constructed as a wheel guiding spring strut assembly 19. The spring strut assembly 19 includes a helical compression spring 20 and a shock absorber 21 which is surrounded by the compression spring 20. Like a link strut, the spring strut assembly 19 is supported on the vehicle body, on one hand, and on a longitudinal control arm 22, on the other hand. As a result of forces acting upon compression of the wheels 13, 14, the spring strut assembly 19 points slantingly upwards.

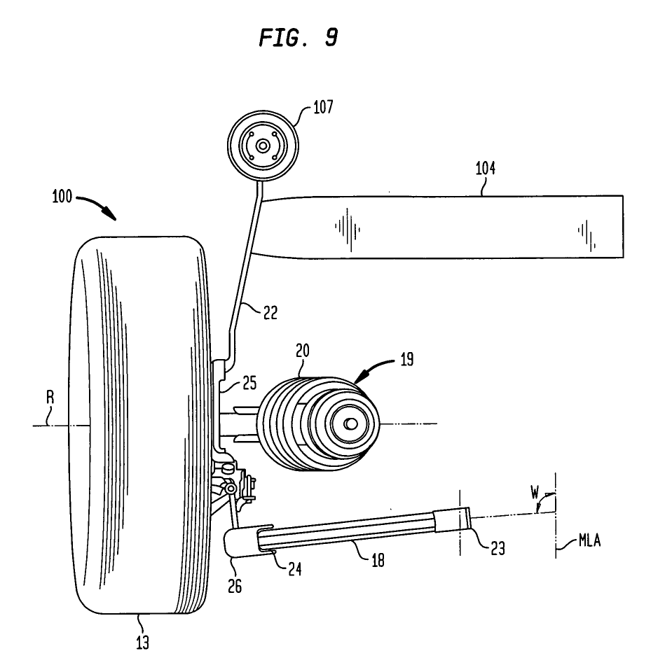

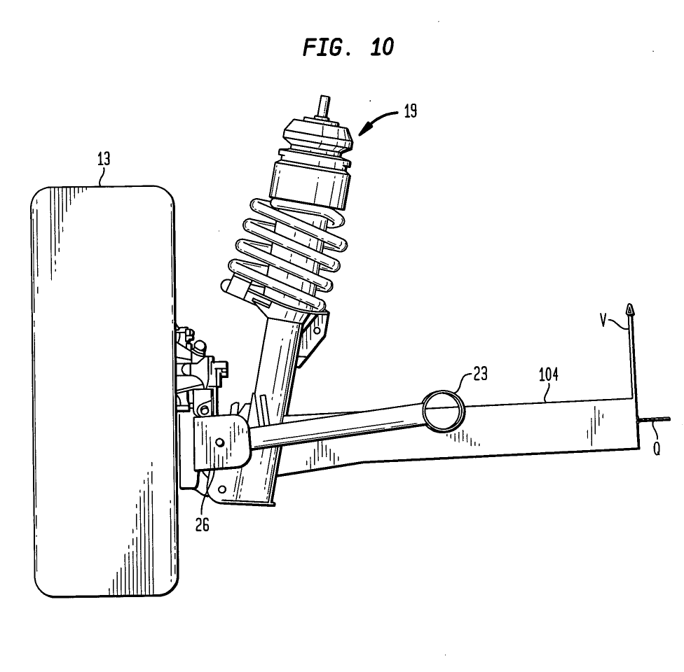

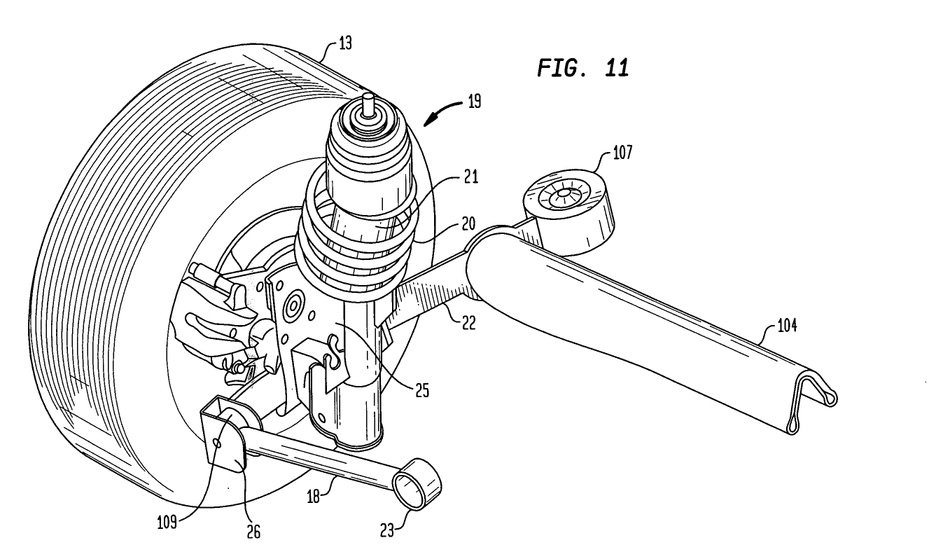

FIG. 9 depicts, by way of example, a concrete embodiment of a torsion suspension 100 according to the present invention substantially in correspondence to FIG. 8, with the difference to FIG. 8 residing in the ascending incline of the link strut 18, as shown in FIG. 10, as compared to the descending incline of the link strut 18 in FIG. 8. The longitudinal control arm 22 is configured here in the form of an upright metal band. In contrast to the embodiment of FIG. 6, the primary bearing 107 is now rotated by 90° and has a longitudinal axis extending out of the drawing plane. In FIG. 6, the longitudinal axis of the primary bearing 107 extends in the drawing plane. The spring strut assembly 19, comprised of helical compression spring 20 and shock absorber 21, as also shown in FIG. 11, is disposed in the area of the wheel axis R, i.e. at a horizontal distance from the link strut 18. The link strut 18 extends at an angle to the longitudinal center axis MLA of the vehicle, with the inner end 23 of the link strut 18 situated closer to the wheel axis R than the opposite end 24 which is proximal to the longitudinal control arm 22. In other words, the indicated angle W is greater than 90°.

As shown in FIG. 9, the metal band to form the longitudinal control arm 22 has a length dimension which is not straight. The metal band angles from the primary bearing 107 slight outwards, with the torsion axle 104 secured at a slanted angle to the longitudinal control arm 22. In the area of the spring strut assembly 19 or the wheel 13, the longitudinal control arm 22 deflects outwardly in U-shaped manner. The U-shaped deflection represents a wheel mounting 25 on which the wheel pin and a brake unit are mounted pointing outwards, and the spring strut assembly 19 is mounted pointing to the vehicle center. Provided on the rear end 109 of the longitudinal control arm 22 is an U-shaped bearing pocket 26 for receiving the link strut 18.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A torsion suspension, comprising:
two longitudinal control arms having front ends and rear ends in travel direction;
a torsion axle extending transversely to and interconnecting the longitudinal control arms;
a bearing assembly for swingably supporting the front ends of the longitudinal control arms in relation to a vehicle body; and
transverse control arms coupled to the rear ends of the longitudinal control arms in one-to-one correspondence for absorbing lateral forces.

2. The torsion suspension of claim 1, wherein the longitudinal control arms are constructed for attachment of wheels, said transverse control arms being coupled to the longitudinal control arms at a location behind a wheel axle of the wheels, as viewed in travel direction.

3. The torsion suspension of claim 1, wherein the longitudinal control arms are defined by a longitudinal axis extending in a longitudinal direction, a transverse axis extending transversely to the travel direction, and a vertical axis extending upwards in perpendicular relationship to the longitudinal axis and in perpendicular relationship to the transverse axis, wherein the longitudinal control arms have at least one length section which extends between a connection area of the torsion axle and the transverse control arms and has a bending resistance which is smaller with respect to bending stress about the vertical axis than with respect to bending stress about the transverse axis.

4. The torsion suspension of claim 3, wherein a section modulus of the longitudinal control arms undergoing flexure is smaller in relation to the vertical axis than a section modulus of the transverse control arms undergoing flexure.

5. The torsion suspension of claim 1, wherein the transverse control arms are arranged transversely to the travel direction.

6. The torsion suspension of claim 1, wherein the transverse control arms have each at least two link struts, each said link strut hinged to the vehicle body and to a corresponding one of the longitudinal control arms.

7. The torsion suspension of claim 6, wherein one of the link struts of each of the transverse control arms represents an upper strut and one of the link struts represents a lower strut, said upper and lower struts having points of articulation at different levels.

8. The torsion suspension of claim 7, wherein the upper and lower struts have different lengths.

9. The torsion suspension of claim 7, wherein the upper strut is implemented as a spring strut assembly having a shock absorber and a helical compression spring surrounding the shock absorber.

10. The torsion suspension of claim 9, wherein the spring strut assembly is connected, at least indirectly, to a corresponding one of the longitudinal control arms in an area of a wheel axle.

11. The torsion suspension of claim 1, wherein the longitudinal control arms are constructed in the form of upright metallic bands.

12. The torsion suspension of claim 1, wherein the metal bands are made from punched bent parts of substantially constant thickness, with a ratio between height and thickness greater than 5:1.

13. The torsion suspension of claim 11, and further comprising a wheel mounting constructed in one piece with the longitudinal control arms.

14. The torsion suspension of claim 13, wherein the wheel mounting is defined by a wheel axis which extends above the longitudinal control arms.

15. The torsion suspension of claim 11, wherein the metal bands are configured with an upwardly widening flanged expansion to realize a substantially T-shaped configuration.

16. The torsion suspension of claim 11, wherein the metal bands are configured to angle from the primary bearings slight outwards and to deflect outwardly in a wheel area in U-shaped manner to define a wheel mounting.
